(19) United States
(12) Patent Application Publication
(10) Pub. No.: US 2019/0283660 A1
(43) Pub. Date: Sep. 19, 2019

(54) HEADLIGHT HOUSING

(71) Applicant: Quadratec, Inc., West Chester, PA (US)

(72) Inventor: Steven M. FISHER, West Chester, PA (US)

(21) Appl. No.: 15/919,963

(22) Filed: Mar. 13, 2018

(51) Int. Cl. B60Q 1/068

(52) U.S. Cl. CPC B60Q 1/0683

(57) ABSTRACT

A headlight housing comprises an adapter having an adapter opening, a plurality of attachment members extending from the adapter, a mount within the adapter opening coupled to the adapter with a pivot member that permits the mount to pivot within the adapter opening about an axis, the mount having a mount opening adapted to receive a headlight inserted into the mount, and an adjuster attached to the adapter for applying force to the mount to cause the mount to pivot within the adapter.

### FIELD OF THE INVENTION

The present invention relates to housing structures, and in particular to housing structures for housing lighting devices such as headlights. More specifically, an apparatus and method are disclosed for housing a headlight in an automotive vehicle.

### BACKGROUND OF THE INVENTION

Headlight technology for automotive vehicles has been subject to numerous advances.

The oldest form of headlight technology currently being used is halogen headlights. In a halogen headlight, a glass tube surrounds a tungsten filament. The tungsten filament is located in a gas, which is usually a combination of nitrogen and argon. Electrical current heats the tungsten filament to create light. As much as 80% of all automotive vehicles in the world include halogen headlights. While these headlights turn on fairly quickly, and are relatively inexpensive, they have disadvantages. Halogen headlights are relatively dim compared to other headlight options. Also, if they are handled by bare hands, the oil on a person's hand leaves residue on the headlight's glass. That residue will significantly shorten the lifespan of the headlight. Halogen headlights are also not the best option when focused illumination is desired.

High Intensity Discharge (HID) headlights were introduced in the 1990s and are also sometimes referred to as Xenon headlights. HID headlights include a mixture of rare metals and gases. The contents of the headlights are heated to generate a bright white (or blue) illumination. HID technology may be two to three times brighter than halogen bulbs, thus they are advantageous to use for night driving. Since HID lamps draw only about 35 W of power, and have a lifespan of approximately 2000 hours, HID lights are more efficient than halogen lights. There are, however, disadvantages to these lights. First, they are very expensive. Second, they may easily fail if not installed correctly. Third, they produce significant glare.

LED (light emitting diode) lights have been available since 2004 but have recently grown in popularity. They have a lifespan of at least 30,000 hours, and do not contain mercury (which is better for the environment). Their small size enables them to be arranged into aesthetically pleasing designs. LED lights also have disadvantages. They produce some heat which can damage other electrical components. Thus, LED headlights require some type of cooling system (fans and heatsinks).

In some cases, LED Matrix allows drivers to leave high beams on permanently. These headlights have the ability to detect and turn light away from other vehicles and pedestrians.

Laser headlights are much brighter than LED headlights. These lights are so bright that they are only activated when the vehicle is going faster than 30 mph. Their brightness enables them to illuminate much further than LED headlights. Their disadvantage is that there are only available for a small number of cars and their costs are very high.

For virtually all automotive vehicles, the housing in which each headlight sits is customized, and thus only specific headlights can be used in that housing. Consumers can only use headlights that are designed to fit in a particular housing. If a user wanted to use a headlight with certain characteristics or technology, and that headlight was not available to consumers for specific automotive vehicle housings, then the user was unable to install a headlight with those specifications in the user's vehicle.

### SUMMARY OF THE INVENTION

A headlight housing comprises an adapter having an adapter opening, a plurality of attachment members extending outwardly from the adapter, a mount within the outer housing and coupled to the adapter with a pivot member that permits the mount to pivot within the adapter opening about an axis, the mount having a mount opening adapted to receive a headlight inserted into a front of the mount, and an adjuster attached to the adapter for applying force to the mount to cause the mount to pivot within the adapter.

### BRIEF DESCRIPTION OF THE DRAWINGS

FIG. 1 is a front perspective drawing of a headlight housing in accordance with an exemplary embodiment of the present invention.

FIG. 2 is a rear perspective drawing of a headlight housing in accordance with an exemplary embodiment of the present invention.

FIG. 3 is cross-sectional side view drawing of a headlight housing in accordance with an exemplary embodiment of the present invention.

FIG. 4 is a perspective drawing of exemplary attachment members for attaching a headlight housing to an automotive vehicle.

FIG. 5 is a cross-sectional view of an exemplary pivot mechanism for enabling pivoting of a headlight in accordance with an exemplary embodiment of the present invention.

FIG. 6 is a cross-sectional view of an exemplary adjuster for adjusting angle of a headlight mounted in the headlight housing.

### DETAILED DESCRIPTION

There are automotive headlights currently on the market in various configurations and that use various technologies. Some of these headlights have been produced for many years because automotive manufacturers have been producing vehicles that use the same headlight configuration year after year.

An automotive manufacturer may work with a headlight manufacture to design a certain type of headlight. This is done to ensure vehicles can be mass-produced, and large supplies of headlights are thus available to be installed in vehicles during manufacturing. Once an automotive vehicle with a certain type of headlight appears on the market, other headlight manufacturers often begin to produce and sell replacement headlights for that vehicle. Customers may wish to purchase these “aftermarket” headlights as a replacement for their current headlight for various reasons. The purchase price on such an “aftermarket” headlight may be less than the purchase price of the original (or OEM) headlight (whether purchased from a dealer for the original vehicle manufacturer or from a dealer that sells the identical original headlight). Alternatively, market availability of the original headlight may be very limited and it might be much easier to purchase an aftermarket version through other trade channels (such as the Internet). A further reason for purchasing an aftermarket headlight is because the headlight may be sold by its original manufacturer using only one type of technology (e.g. Halogen), and the vehicle owner may wish to install headlights on his vehicle that use another type of technology (e.g. LED).

One exemplary vehicle has been manufactured in the United States for many years and has been using one headlight configuration (or partial configuration) for that entire time period. Thus, many aftermarket replacement parts are available for that vehicle using various headlight technologies. The manufacturer recently made a radical change to the receptacle in its vehicles that receive headlights, and thus headlights for earlier model years (and all aftermarket replacements for those headlights) no longer fit into the latest model of that vehicle. As a result, while consumers once had numerous options for replacing headlights in earlier model years for that vehicle, their options have become severely limited. Furthermore, the configuration of the headlight for prior model years was relatively small and simple while the new headlight configuration for that vehicle is significantly larger, much more complex (and certainly more expensive than the currently available aftermarket headlights for earlier model years). Furthermore, the new headlight configuration may only be available from a single manufacturer. Without other manufacturers competing with that product, cost for a replacement headlight may be very high. In addition, while earlier model year headlights are available using a variety of different headlight technologies, the number of headlight technologies available for the new headlight configuration is severely limited.

If an automotive vehicle is not configured to receive a headlight with a certain size/shape/configuration, the average consumer has no way to install that headlight in a vehicle. In such a situation, the configuration of the headlight and the configuration of the vehicle receptacle that receives a headlight is a mismatch. Thus, if a consumer wishes to install a certain headlight in their vehicle, and the vehicle is not designed to accept that headlight, the consumer cannot proceed. Furthermore, in the situation where a certain type of vehicle was manufactured for many years to accept a headlight in one configuration, and the headlight configuration accepted by an automotive vehicle for the latest model year suddenly changes, none of the headlights currently on the market for the previous model years can be used with the new model year vehicle. Consumers in that situation are thus forced to purchase a replacement headlight from the one manufacturer manufacturing headlights for the new model year vehicle. Furthermore, if previous model year headlights were cheaper than the headlight for the new model year, consumers are forced to pay the higher cost of the headlight for the new model year. Headlights in that situation, that are available as aftermarket parts for previous model year vehicles, are not suitable for headlight replacement for the current model year.

Thus, if available, it would be highly desirable for a consumer to be able to use (in their vehicle) headlights that do not match the configuration of the headlights being used in the current model year. Accordingly, the inventor has created an interface device that allows headlights with one configuration to be used with automotive vehicles that are expecting headlights in another configuration. The interface is useful, for example, to use a smaller headlight than what was intended to be accommodated by a particular vehicle. By using the word “smaller” what is meant is one headlight with at least one external dimension smaller than another headlight. The external dimension may include, for example, width and/or height.

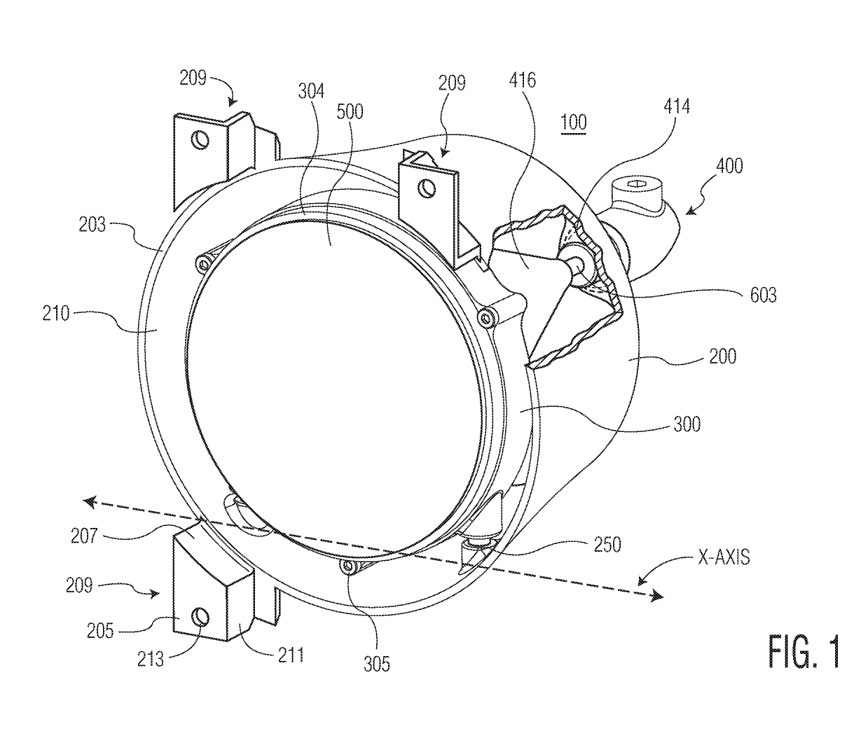

FIG. 1 is a front perspective drawing of headlight housing 100 in accordance with an exemplary embodiment of the present invention. This exemplary headlight housing 100 allows an automotive vehicle that is designed to accept a headlight with one configuration to accept a headlight with another configuration. Furthermore, this housing 100 allows an automotive vehicle to accept a headlight with any exterior dimension (of what the headlight is replacing) to be decreased.

As shown in FIG. 1, headlight housing 100 includes adapter 200. Adapter 200 is formed in a shape and size so that it is a corresponding match for a containment structure in an automotive vehicle that is designed to hold a headlight of a particular configuration. By referring to “containment structure” this may refer to an opening in the front of a vehicle that is designed to accommodate a headlight. The opening may be in a one (or more) unified physical member(s), or the opening may be the result of a space between other structures that define a space that receives a headlight.

In the perspective drawing shown in FIG. 1, the exterior of adapter 200 has a circular configuration, however this is merely exemplary. The outer shape of adapter 200 may be any shape that corresponds to the containment structure of a vehicle that is to receive headlight housing 100. Adapter 200 may be comprised of a plurality of different materials including plastic and/or metal. Furthermore, adapter 200 is shown as a solid ring; however the ring that comprises adapter 200 need not necessarily be a solid member. Thus, adapter 200 may comprise only portions or fragments of what is shown in FIG. 1 (or may have openings or gaps therein).

Adapter 200 includes a plurality of projections 209 that project outwardly from adapter 200. Projections 209 are attachment points; they provide appropriate structure to attach adapter 200 to a vehicle. In an exemplary embodiment of the present invention, three projections 209 are provided for attaching adapter 200 to an automotive vehicle although this is merely exemplary. Furthermore, if more than one projection 209 is present, projections 209 are not necessarily equidistant from each other about the exterior of adapter 200. For example, in one embodiment, the distance between projections 209 may purposely be non-equidistant to ensure proper orientation of headlight housing 100 within an automotive vehicle.

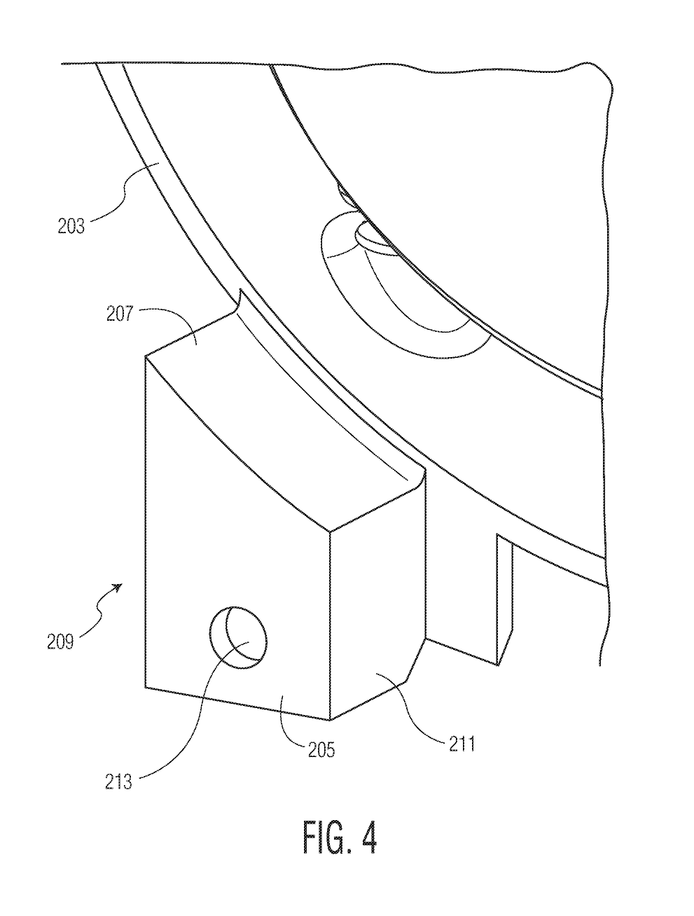

In one exemplary embodiment of the present invention, each projection 209 includes opening 213. Opening 213 is the female counterpart of a male structure (or a female structure that receives a bolt) that is located on (or within) the automotive vehicle that is receiving headlight housing 100. In accordance with the exemplary embodiment illustrated in FIG. 1, an automotive vehicle may include three male members (or female members to receive a bolt) in corresponding positions to the three openings 213 as shown. Thus, the male members on (or in) the automotive vehicle (or female members that receive a bolt) may align with openings 213 in order to enable installation of headlight housing 100 to an automotive vehicle. Also, as previously explained, in one exemplary embodiment, the male members that engage openings 213 (or the female members that engage a bolt that extends through openings 213) are non-equidistant from each other (as are openings 213 in the exemplary embodiment). In a further exemplary embodiment, headlight 500 (with exemplary wiring 502) is set back within the automotive vehicle (i.e. it may not be flush with the front of the automotive vehicle that is receiving headlight housing 100). Thus, projections 209 may include structure so that each opening 213 is located forward of front edge 203. The optional structure which allows opening 213 to be located forward of front edge 203 is more clearly illustrated in FIG. 4 and is described in further detail below.

Adapter 200 forms adapter opening 210. Adapter opening 210 is of sufficient size to accommodate mount 300. FIG. 1 illustrates mount 300 as being circular in shape, although this is merely exemplary. Mount 300 defines mount opening 310. Mount opening 310 is formed with a shape that accommodates a headlight that a user may wish to use with their automotive vehicle. Mount opening 310 is shown having a round shape, but this is merely exemplary to illustrate the ability to use a round headlight. Thus, it is understood to one of ordinary skill in the art that mount opening 310 may have other shapes in order to accommodate other headlights that are being used. For example, if headlight housing 100 is desired to be used with a rectangular headlight, then mount opening 310 will have a rectangular shape.

Mount 300 may be comprised of a plurality of materials such as plastic and/or metal. Furthermore, mount 300 may be formed as a single unitary piece, although this is merely exemplary. In the example illustrated in FIG. 1, mount 300 is formed of three major components 304, each major component 304 comprising one third of mount 300. If mount 300 is comprised of a plurality of components, attachment members 305 are included for attaching the various portions together in order to form mount 300.

One exemplary manner by which mount 300 is attached to adapter 200 is via pivots 250. FIG. 1 illustrates an X axis about which mount 300 (and thus a headlight installed within mount 300) may rotate. As shown, this allows a headlight to rotate up and down. Such rotation may be desirable depending upon the height of a headlight mounted within mount 300 relative to the ground. If, for example, a vehicle that includes headlight 500 is riding “low,” it may be necessary to adjust headlight 500 with an upward tilt. If by contrast a vehicle that includes headlight 500 is riding “high,” it may be necessary to tilt headlight 500 downward. A vehicle may ride low if the vehicle is carrying, or has been customized to include, significant weight. A vehicle suspension system may also cause a vehicle to ride low. By contrast, a vehicle that is relatively light (or has been customized to lighten its weight) may ride high. In addition, tire choice or suspension choice may cause a vehicle to ride high. If the vehicle is riding high, downward tilt of headlight 500 may be desirable in order to prevent glare to oncoming traffic. If the vehicle is riding low, upward tilt of headlight 500 may be desirable in order to provide illumination an adequate distance ahead of a vehicle while the vehicle is driving.

FIG. 1 illustrates two pivots 250 but this is merely exemplary. There may be more or less pivots than what is shown. For example, a third optional pivot 250 may be placed between the two pivots 250 that are illustrated in FIG. 1. Alternatively, a single pivot 250 may be included between the two locations where two pivots 250 are shown in FIG. 1. Also, the location of pivots 250 is exemplary. Pivots 250 may be included in a lower position than what is shown in FIG. 1, or in a higher position than what is shown in FIG. 1. In one example, pivots are included at a location halfway between the top and bottom of mount 300. Such pivots may be located in a horizontal orientation relative to mount 300, but again this is merely exemplary. In the example shown in FIG. 1, the pivot members are situated so that headlight 500 is rotating about a horizontal axis below a center of mount 300 although this is again merely exemplary. In alternative exemplary embodiments, headlight 500 rotates about an axis at a center of mount 300 or alternatively above the center of mount 300.

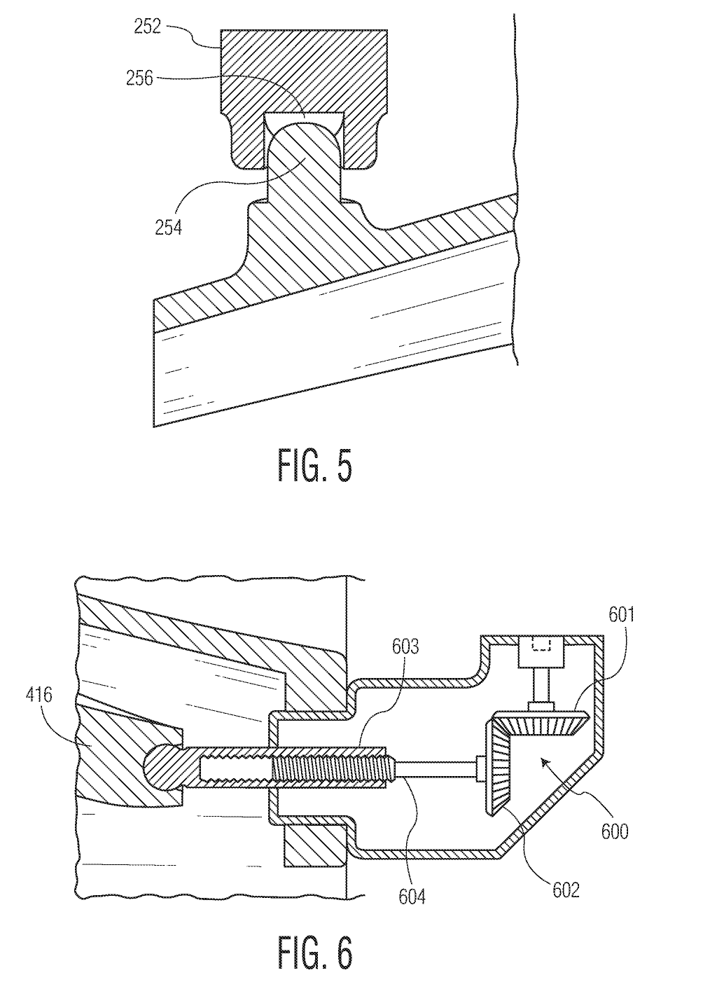

Pivots 250 may be implemented using various structures that enable mount 300 to pivot relative to adapter 200. One exemplary embodiment of pivots 250 is illustrated in FIG. 5 and is further described below. In summary, pivots 250 may be implemented in various manners, including a hinge type implementation, a ball and socket type of implementation, a rounded end in a concave section, a coaxial pivot arrangement (with a male elongated member rotating within a female elongated member or vice versa), etc.

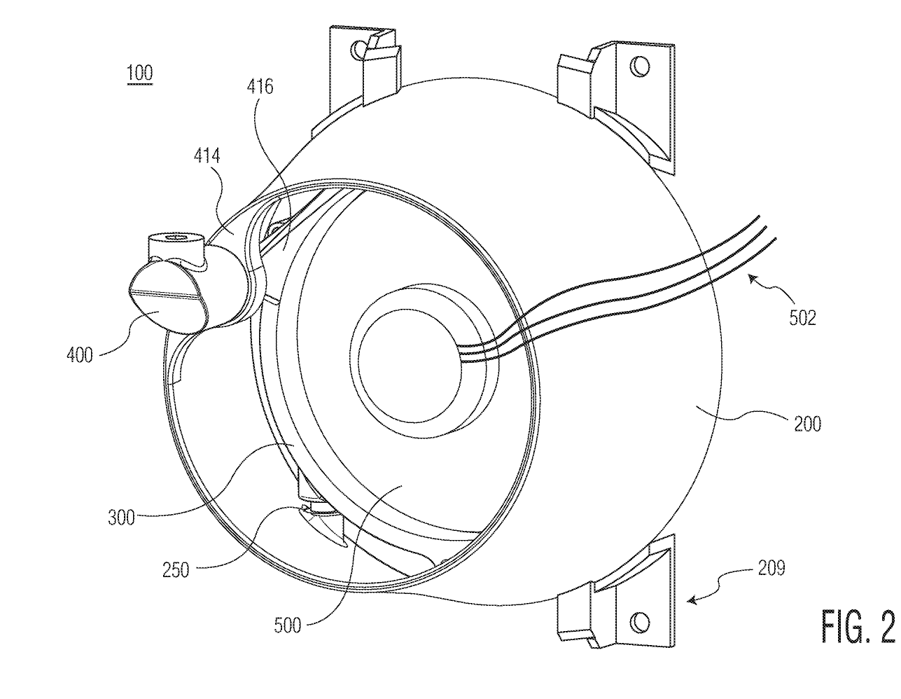

Mount 300 (with bulb 500 installed therein) is tilted about the X axis by virtue of an appropriate adjustment mechanism. This adjustment mechanism is more clearly shown in FIGS. 2, 3 and 6 and is described below.

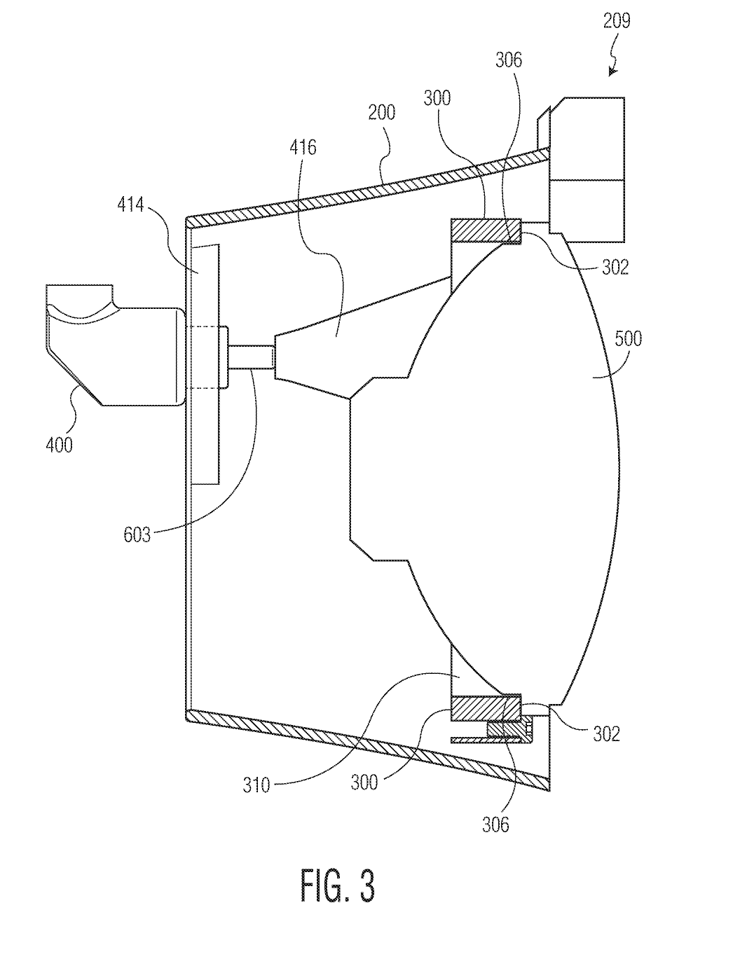

FIG. 2 is a rear perspective drawing and FIG. 3 is a side view of an exemplary embodiment of the present invention. FIG. 2 illustrates features that may be found in an exemplary embodiment of the present invention to rotate mount 300 about the X axis. Adjuster 400 may be included. Adjuster 400 includes shaft 410 that is able to move along an axis as shown. Shaft 410 in turn is attached to shaft coupler 416. Shaft coupler 416 in turn is attached to mount 300. Thus, as shaft 410 slides in and out within adjuster 400, shaft coupler 416 applies force to mount 300 in order to cause mount 300 to rotate about the X axis.

As further illustrated in FIG. 3, adjuster 400 has the purpose of rotating headlight 500 about the X axis. Adjuster 400 is attached to mount 300 via shaft coupler 416. Attachment member 414 further maintains adjuster 400 in position relative to shaft coupler 416. Shaft 410 is shown extending from adjuster 400. Shaft 410 is attached to shaft coupler 416 which in turn is attached to mount 300. Mount 300 includes step 306 which accepts an outer edge of a headlight as shown in FIG. 3. Bulb 500 may optionally include outer step 302. The outer step of bulb 500 fits into outer step 306 of mount 300 in order to hold bolt 500 in place. In one exemplary embodiment, bulb 500 is held in place with friction. The step that is shown is merely exemplary as other structures may be used to hold bulb 500 in place.

FIG. 4 is a perspective drawing which further illustrates how projection 209 may be formed. As shown in FIG. 4, and in one exemplary embodiment, projection 209 may include extension 207 which extends forward of front edge 203. Extending in a perpendicular manner from extension 207 is front wall 205. Opening 213 is formed in front wall 205 and serves the purpose of receiving a male member extending from the automotive vehicle (or is bolted, for example, to the vehicle through a bolt that extends through opening 213 and then attaches to the vehicle). Sidewall 211 is also optionally attached to front wall 205 and extension 207. One or all of extension 207, front wall 205, and/or sidewall 211 may serve the purpose of sitting in contact with further alignment structures in the automotive vehicle in order to help maintain headlight housing 100 in a proper orientation.

FIG. 5 is a perspective drawing which further illustrates the structure associated with pivot 250. As shown, pivot 250 may comprise shaft 252 that extends from mount 300 and terminates in concave portion 256. Ball 254 sits in concave portion 256. Thus, as shaft 410 extends from adjuster 400 and retracts into adjuster 400, concave portion 256 rotates about ball 254. While the drawing shows a female member above a male member, this is merely exemplary as the female member may also be below the male member.

The above-described structure with regard to pivot 200 is merely exemplary as other structures may also be used. In place of a combination of a ball and concave structure, a ball and socket configuration may be used. As another alternative, a hinge structure may be used.

FIG. 6 is a cutaway drawing that shows the interior of adjuster 400. As shown in FIG. 6, adjuster 400, in one exemplary embodiment, may include bevel gear assembly 600, which includes bevel gear 601 and bevel gear 602. Bevel gear 602 is attached to outside threaded shaft 604. Outside threaded shaft 604 is located within inside threaded shaft 603. Thus, bevel gear 601 rotates bevel gear 602. Bevel gear 602 rotates outside threaded shaft 604, and outside threaded shaft 604 rotates within inside threaded shaft 603. Inside threaded shaft 603 is rigidly attached to shaft coupler 416. Thus, inside threaded shaft 604 is prevented from engaging in rotational motion. As inside threaded shaft 604 rotates, inside threaded shaft 603 moves in and out in order to apply force towards or against mount 300. In this manner, mount 300 rotates about the X axis.

In accordance with a further exemplary embodiment of the present invention, a process will now be described for installing headlight housing 100 into an automotive vehicle. As an optional pre-step, an existing headlight (not shown) is removed from an automotive vehicle. Then, as a first step, headlight 500 is inserted into mount 300. Headlight 500 is optionally of smaller dimension than the existing headlight that may have been removed. When “smaller dimension” is stated, what is meant is a smaller dimension in a corresponding location. Thus, if the existing headlight (hereafter the “first” headlight) has a first external dimension then headlight 500 (hereafter the “second” headlight) has a second external dimension smaller than the first external dimension in a respectively corresponding location. The respectively corresponding location can be an external location. Exemplary locations include width across the front of the headlight, height across the front of the headlight, circumference about the outside of the headlight, etc.

In one exemplary embodiment, and as previously described, the outer edge of bulb 500 is stepped, and therefore bulb 500 is inserted within the stepped edge 306 of mount 300. Once bulb 500 has been inserted into mount 300, headlight housing 100 may be inserted into the automotive vehicle. In order to accomplish this insertion, each opening 213 in each respective projection 209 is aligned with counterpart male engagement members situated within the automotive vehicle. In an exemplary embodiment, projections 209 are not equidistant from each other, and therefore headlight housing 100 must be oriented so that alignment of each opening 213 and corresponding male projections within the automotive vehicle is achieved. After openings 213 and corresponding male projections in the automotive vehicle are aligned, headlight housing 100 is pressed into the automotive vehicle until openings 213 and corresponding male projections engage. After this engagement has occurred (or in some situations prior to engagement), bevel gear 601 of adjuster 400 is rotated until bulb 500, after rotating about the X axis, is angled as desired. Other structural members may then be engaged or closed in order to secure headlight housing 100 to the automotive vehicle.

Bevel gear assembly is included in order to allow adjustment of bulb 500 about the x axis from above, but it is contemplated that other mechanisms may be used to adjust bulb 500 about the x axis. The mechanism described above is merely exemplary.

In the above explanation, projection 209 has been described as having a female member that engages a male member of the automotive vehicle. It is understood, however, that this is merely exemplary and other forms of engagement may be used. For example, instead of a female-male coupling, a male-female coupling may be used. Furthermore, other alignment structures may be used to properly orient headlight housing 100 within an automotive vehicle as would be understood to one of ordinary skill in the art.

While the present invention has been described herein with reference to exemplary embodiments, it should be understood that the invention is not limited thereto. Those skilled in the art with an access to the teachings herein will recognize additional modifications, applications, and embodiments within the scope thereof and additional fields in which the invention would be useful.

The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein, it is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

1. A headlight housing comprising:
an adapter having an adapter opening, the adapter opening having a width across a front of the adapter;
a plurality of attachment members extending from the adapter;
a mount within the adapter opening and coupled to the adapter with a pivot member that permits the mount to pivot within the adapter about an axis, the mount having a mount opening adapted to receive a headlight inserted into the mount, wherein the mount opening occupies a majority of the width across the front of the adapter;
an adjuster attached to the adapter for applying force to the mount to cause the mount to pivot within the adapter.

2. A headlight housing according to claim 1, wherein the axis is a horizontal axis, the pivot member is one of a plurality of pivot members, and the horizontal axis is below a center of the mount.

3. A headlight housing according to claim 1, wherein the pivot member is below the mount and between the mount and the adapter.

4. A headlight housing according to claim 1, wherein the attachment members are arranged about the adapter and are non-equidistant from each other.

5. A headlight housing according to claim 1, wherein said attachment members extend forward past a front edge of said adapter and include rear surfaces that a coplanar.

6. A headlight housing according to claim 1, where said mount includes a front edge that is stepped.

7. A method of using a headlight housing, said method comprising the steps of:
removing a first headlight, with a first exterior dimension, from an automotive vehicle;
inserting a second headlight, having a second exterior dimension smaller than the first dimension in respective corresponding locations, into the headlight housing; and
inserting the headlight housing into the automotive vehicle where the first headlight was previously located;
wherein the headlight housing includes an adapter having an adapter opening, the adapter opening having a width across a front of the adapter, and a mount within the adapter opening, the mount having a mount opening adapted to receive the second headlight, wherein the mount opening occupies a majority of the width across the front of the adapter.

8. A method according to claim 7, said method further comprising the step of rotating the second headlight within the vehicle.

9. A method according to claim 7, said housing including:
an adapter having an adapter opening;
a plurality of attachment members extending outwardly from the adapter;
a mount within the outer housing and coupled to the adapter with a pivot member that permits the mount to pivot within the adapter about an axis, the mount having a mount opening adapted to receive a headlight inserted into a front of the mount;
an adjuster attached to the adapter for applying force to the mount to cause the mount to pivot within the adapter
wherein said headlight is inserted into the mount opening;
b) actuating said adjuster in order to pivot the mount about the axis; and
b) inserting said headlight housing into said automotive vehicle.

10. A method according to claim 9, where the axis is a horizontal axis, the pivot member is one of a plurality of pivot members, and the horizontal axis is below a center of the mount.

11. A method according to claim 9, wherein the pivot member is below the mount and between the mount and the adapter.

12. A method according to claim 9, wherein the attachment members are arranged about the adapter and are non-equidistant from each other.

13. A method according to claim 9, wherein said attachment members extend forward past a front edge of said adapter and include rear surfaces that a coplanar.

14. A method according to claim 9, wherein the axis is a horizontal axis.

15. A method according to claim 9, where said mount includes a front edge that is stepped.

16. A headlight housing comprising:
an outer housing adapted to be inserted into a vehicle where a first headlight is intended to be located;
an adapter within said outer housing adapted to receive a second headlight, said second headlight having an second exterior dimension smaller than a first exterior dimension of said first headlight in a respectively corresponding location;
the adapter having an adapter opening, the adapter opening having a width across a front of the adapter;
a mount within the adapter opening, the mount having a mount opening adapted to receive the second headlight, wherein the mount opening occupies a majority of the width across the front of the adapter.

17. A headlight housing according to claim 1, wherein the mount opening occupies less than all of the width across the front of the adapter.

18. A headlight housing according to claim 16, wherein the mount opening occupies less than all of the width across the front of the adapter.
